(19) United States
(12) Patent Application Publication
(10) Pub. No.: US 2014/0180576 A1
(43) Pub. Date: Jun. 26, 2014

(54) ESTIMATION OF TIME OF ARRIVAL BASED UPON AMBIENT IDENTIFIABLE WIRELESS SIGNAL SOURCES ENCOUNTERED ALONG A ROUTE

(71) Applicants: Anthony G. LaMarca, Seattle, WA (US); Jaroslaw J. Sydir, San Jose, CA (US)

(72) Inventors: Anthony G. LaMarca, Seattle, WA (US); Jaroslaw J. Sydir, San Jose, CA (US)

(21) Appl. No.: 13/726,387

(22) Filed: Dec. 24, 2012

(51) Int. Cl. G01C 21/00

(52) U.S. Cl. CPC G01C 21/00
USPC 701/465

(57) ABSTRACT

Described herein are technologies related to estimating a route being traveled by a mobile device based upon detection of an array of ambient identifiable wireless signal (IWS) sources while the device is traveling. More particularly, technologies disclosed herein predict estimated-time-of-arrival (ETA). This Abstract is submitted with the understanding that it will not be used to interpret or limit the scope or meaning of the claims.

### BACKGROUND

The use of mobile devices, such as smartphones, is nearly ubiquitous. Many of these mobile devices include the capability to determine their geo-physical (e.g., geographic) location. That is, the mobile device is capable of determining its location in the real world. Conventionally, location determination is typically accomplished by using Global Positioning Systems (GPS), some form of telemetry based upon multiple radio signals (e.g., cellular), internet protocol (IP) geo-location, or some combination thereof.

A collection of so-called location-based services (LBSs) are emerging that take advantage of the location-awareness capability of the mobile devices that so many people are carrying with them each day. For example, LBSs include targeted advertising, social networking, locating friends (“check-ins”), photo-tagging, life-logging, location-based games, fitness monitoring, etc. LBS may include vehicle or parcel tracking as well.

Using the location-detection capability of mobile devices, some LBSs offer destination or estimated-time-of-arrival (ETA) prediction. Such predictions may be useful to avoid congestion, identify convenient and interesting waypoints (e.g., a gas station, coffee shop, etc.), coordinate arrival with other people, and the like. GPS technology is the most common technology utilized for conventional ETA prediction.

### BRIEF DESCRIPTION OF THE DRAWINGS

FIG. 1 shows an example neighborhood map that is used to illustrate implementations in accordance with the description herein.

FIG. 2 shows an example route graph that is used to illustrate implementations in accordance with the description herein.

FIG. 3 illustrates an example system in accordance with one or more implementations described herein.

FIGS. 4-6 illustrate processes in accordance with one or more implementations described herein.

FIG. 7 illustrates an example computing device to implement in accordance with the technologies described herein.

FIG. 8 illustrates an example device to implement in accordance with the technologies described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Disclosed herein are technologies for estimating a route being traveled by a mobile device based upon detection of an array of ambient identifiable wireless signal (IWS) sources while the device is traveling. More particularly, technologies disclosed herein predict estimated-time-of-arrival (ETA).

In one or more implementations described herein, a mobile device models and tracks the places that a user commonly visits and the paths the user takes between these places. Modeling and tracking is done in a power-efficient way using the results of periodic (approximately once per minute, for example) wireless fidelity (“Wi-Fi”) scans. This technique produces a graph-based model of a user's patterns in which nodes and edges denote the places and routes between them.

One or more implementations of technology described herein facilitates an on-going calculation of the estimated-time-of-arrival (ETA) at the user's likely destinations while the user is traveling along a frequently traveled route. Traveling from home to work is an example of a frequently traveled route. Over many trips on a particular frequently traveled route, one or more implementations of technology described herein tracks historical timing information along that route. Using that historical information, one or more implementations of technology described herein calculates ETA based upon timing information of the present route being traveled.

Being able to accurately predict route, destination, and ETA has a several applications, such as:
Accurate prediction of destination and arrival time allows for smarter budgeting of limited resources (e.g. battery, restaurant tables, parking spaces, efficient HVAC [heating, ventilation and air conditioning] management, and networking bandwidth);
Accurate route and timing information enables prediction of network resources likely to be encountered on route (e.g. areas of underutilized 4G radio for cloud/client synchronization);
Route/destination/ETA info has direct use in social networking for keeping people aware of the activities of friends and family.

### Location Awareness

Location awareness involves the mobile device determining its present location. Conventional location-determination approaches include GPS and Wi-Fi and cellular signal positioning (e.g., triangulation, trilateration, and other forms of interpolation and extrapolation) to determine geo-physical location relative to multiple signal sources. GPS provides near-ubiquitous location coverage outdoors and a GPS enabled typical smartphone can estimate its location with three to five meter accuracy. For signal positioning, the signal sources can use cellular or a variant of IEEE 802.11 (i.e., Wi-Fi). Signal-positioning approaches rely upon a map of signal sources whose locations are known to infer a location of a device.

However, GPS technology is resource intensive. In particular, GPS technology is computationally demanding and power hungry. Most users have learned to use their GPS sparingly when their mobile device is battery dependent. Otherwise, the GPS quickly drains the battery of their mobile device. In addition, GPS technology is dependent upon reception of signals from geosynchronous satellites. Indoors as well as on city streets with surrounding tall building, it is common for a mobile device to fail to receive sufficient signals to make reliable GPS calculations.

Conventional approaches rely upon determination of physical or geophysical location to estimate route, predict destination, and calculate estimated time of arrival (“ETA”). Unlike those conventional approaches, one or more implementations of the technology described herein learn and recognize a user frequently used routes based upon the “observed” ambient radio environment along the routes.

Unlike the conventional approaches, one or more implementations of the technology described herein employ discrete location estimates that are more like “logical places” than two-dimensional or three-dimensional locations. One or more implementations are self-training and require no database or map of radio sources. In addition, one or more implementations require only infrequent radio scans and no data connection. This results in vastly lower power usage than GPS or Wi-Fi localization approaches. It may be up to 100 times less.

One or more implementations include, for example, a mobile device recognizing and learning a frequented discrete location based on the “observed” ambient radio environment at that location. In particular, the mobile device can recognize and learn which ambient identifiable wireless (“IWS”) sources are part of a topography within reception range at that discrete location.

A wireless access point (WAP) is a specific example of an ambient IWS source. The IWS sources are called ambient herein because they may be detected or “observed” in the environment while a mobile device moves about the world. The IWS sources are called “identifiable” because each is uniquely identifiable. For example, each WAP may be uniquely identified by its basic service set identification (BSSID) or media access card (MAC) address. Of course, other identifying characteristics may be used alone or in combination with each other or with the BSSID or MAC address. Examples of such other identifying characteristics include service set identification (SSID) and received signal strength indication (RSSI).

Geo-location, also called geo-physical location, includes determination of a real-world geographic location of an object or person. “Physical location” is a broader term than geo-location and includes a determination of any real-world location of the object or person.

### ETA Prediction

Conventional approaches to prediction of ETA are often based upon a route generated using global positioning system (GPS) or similar signal telemetry technology. A user typically provides the destination information to a conventional navigational system. That system generates a route from the present location to the destination. The conventional navigational system provides an ETA based upon the generated route and the assumed travel conditions (e.g., typical speeds on the roads on the generated route, typical traffic conditions, etc.) While traveling, the conventional navigational system determines absolute geo-coordinates en route and updates ETA accordingly.

Unfortunately, the conventional approaches assume that the user is travelling via the most direct, efficient route. This is something people often have reasons to not do. In addition, the conventional approaches must assume (or the user must provide) a mode of transportation to do routing/speed estimation. A mode of transportation is, for example, driving or riding in an automobile, riding a bike, and walking. Moreover, things such as traffic often affect the assumed rate of travel with the conventional approaches and weather conditions and often such conditions are not taken into account with the route and ETA calculations.

### Example Scenario

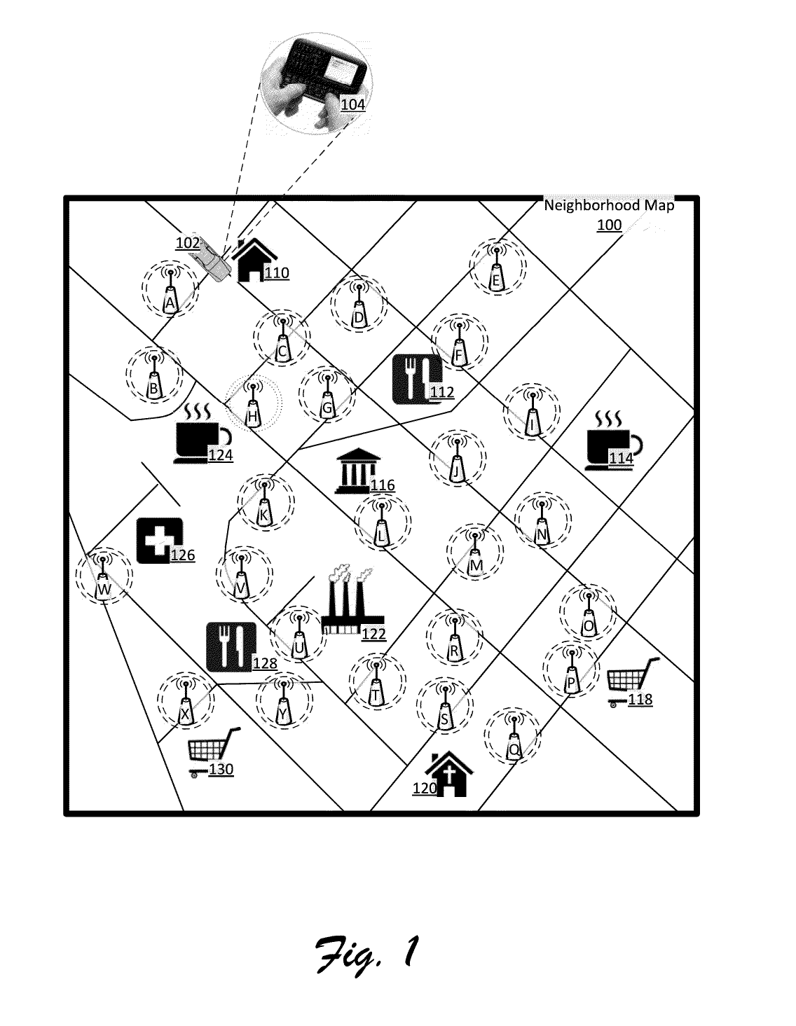

FIG. 1 includes an example neighborhood map 100 that is used to illustrate example scenarios in which one or more implementations of the technology described here may be employed. For illustration purpose, the map 100 shows an automobile 102 on a road that has a driver or passenger (not shown) with an active mobile device 104. While the mobile device 104 is active, a user does not need to interact with it. Indeed, if that user is the driver of the automobile, such action is generally unsafe. Indeed, with implementations described herein, the mobile device 104 may be programmed to automatically act without interaction with the driver while driving. This helps a driver avoid potentially dangerous distractions.

The map 100 also shows several points of interest (POIs), which may be known or determined start points or end points (i.e., destination) of a route traveled by user with the mobile device 104. The POIs depicted in FIG. 1 include a home 110, a diner 112, a café 114 (i.e., coffee shop), a school 116, a grocery store 118, a church 120, a factory 122 (i.e., work), another café 124, a doctor's office 126, a restaurant 128, and a shopping center 130.

Also, the map 100 shows many wireless access points (WAPs) distributed about the neighborhood. Each WAP is labeled with a capital letter ranging from A to Y. A dashed double-lined circle indicates the range of each depicted WAP. While not shown as such in map 100, each POI depicted in FIG. 1 also contains one or more WAPs.

Once the IWS source is uniquely identified by a mobile device, an implementation may assign a unique identifier (ID) for convenience of handling. For example, the IWS source at a person's home may be labeled “Home,” as is shown at 110 in the map 100.

With at least one implementation, a list of ambient IWS sources is tracked when the mobile device 104 is active. Of course, when the user is stationary, the ambient IWS sources do not change or at least varies little. However, when the user travels (with the mobile device 104) new IWS sources are noted along the travel path. For example, the user may be walking, running, in a motor vehicle, train, or some via some other sort of ground transport.

For example, with reference to map 100, presume that Dorothy spends eight hours at work 122. During the workday, the mobile device 104 records one or more IWS sources that have been or will be designated “Work.” After her workday, she drives to the shopping center 130 in her automobile 102. While traveling from work 122 to the store 118, her mobile device 104 encounters IWS sources labeled U, T, R, and P. After she takes this path many times, the pattern of Work, U, T, R, and P and Store will reoccur frequently. At that point, that pattern may be recognized route and identified. For convenience, that route is called Work→Store here. The naming convention follows the pattern of source, arrow, and then destination. The arrow indicates the directional nature of the routes. Of course, because other paths between work 122 and the store 118 exist, other routes may have the same label (Work→Store). For example, Work→Store may include Work, T, M, N, O, Store.

Instead of determining and tracking physical or geophysical locations like as are depicted on a map, the technology described herein tracks discrete places, which are the ambient IWSs encountered, and determines a route based, at least in part, upon an ordered pattern of such discrete places.

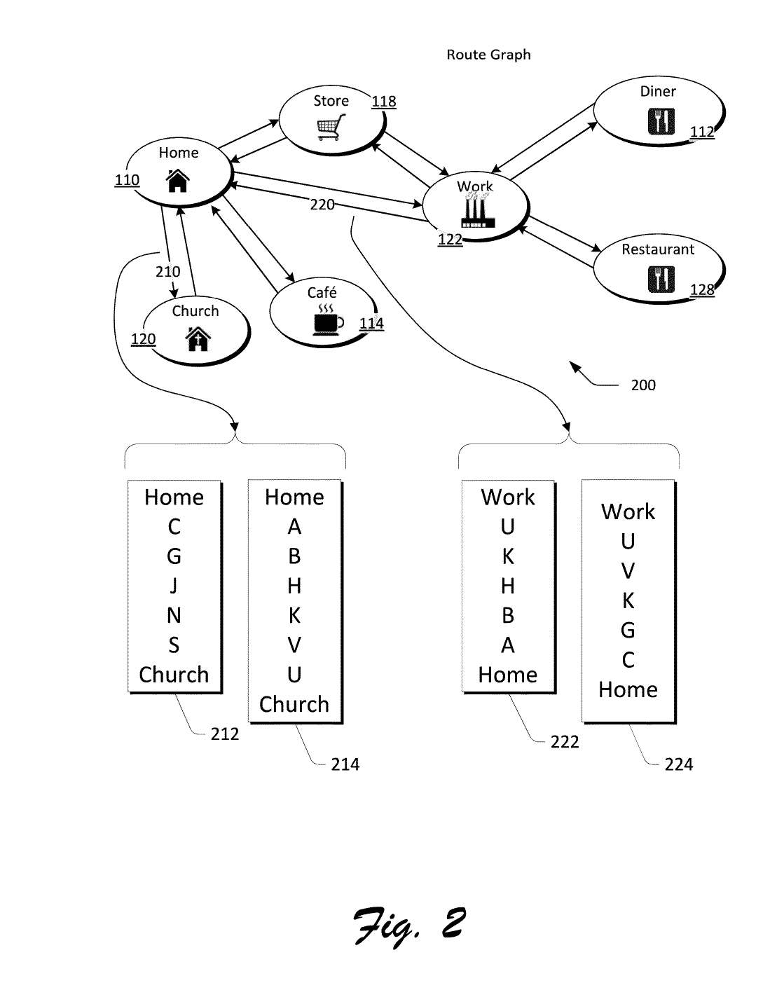

FIG. 2 shows a route graph 200, which is a logical depiction of some example routes that Dorothy has taken with her mobile device 104. Logically, Dorothy's places and routes can be viewed as a graph with connections between places that have been traveled between directly. The graph 200 includes example sources (i.e., start points) and destinations (i.e., end points) of the example routes. Those example sources/destinations are selected from those depicted in the map 100. The selected example sources/destinations include home 110, church 120, store 118, café 114, work 122, diner 112, and restaurant 128.

In the route graph 200, the arrows indicate the route and direction of the route between points. For Home→Church route 210, the mobile device 104 has, for example, recorded at least two different paths, as represented by route datasets 212 and 214, respectively. Route dataset 212 includes Home, C, G, J, N, S, and Church. Route dataset 214 includes Home, A, B, H, K, V, U, and Church. For Work→Home route 220, the mobile device has, for example, recorded at least two different paths, as represented by route datasets 222 and 224, respectively. Route dataset 222 includes Work, U, K, H, B, A, and Home. Route dataset 224 includes Work, U, V, K, G, C, and Home.

The depicted route datasets are one possible implementation. Other implementations, like those described herein, may be more complex. In those implementations, each given route (e.g., route of Work→Home) has one dataset that tracks all ambient IWS sources encountered each time trip from that start point to that destination is taken. Also, other information (such as timing) may be tracked in the route dataset as well.

At any given time, Dorothy is either in a single place or is en route to a new place. Since routes overlap in the physical world and since routes pass near places she might stop, it is often not possible to predict Dorothy's state as a singular route or place. For example, when Dorothy drives out of work 122, she may be going home 110, to a café 124, or possibly to the school 116 to pick up the kids. Since all three places lay along the same path, it may be hard to determine which path you are on solely from the environment. Even a passenger in the automobile 102 with Dorothy is likely unable to determine her destination using the environment alone.

Therefore, the implementations described herein consider all of the three places as possible destinations. Further, consider that Dorothy may encounter a red traffic light on the same corner as the café 124. For the sixty seconds that Dorothy waits for the light to continue on home 110, implementations will take into consideration that Dorothy has, in fact, stopped for coffee. To accommodate this, the implementations predict the user's state as being in at most one single place (e.g., café 124) and/or traveling one of a set of possible routes. (e.g. {‘Work->Home’, ‘Work->Store, ‘Work->café}).

The technology described herein may utilize any new or existing place-recognition technology that learns and recognizes when a user is visiting a particular place. For example, the technology may be linked to a workplace security system and note that the user is located at work 122 because she has scanned her identification badge to gain entry into the work buildings. Otherwise, via data entry, a user may simply identify an IWS source or a collection of such sources with a name, such as “work.”

### Example System

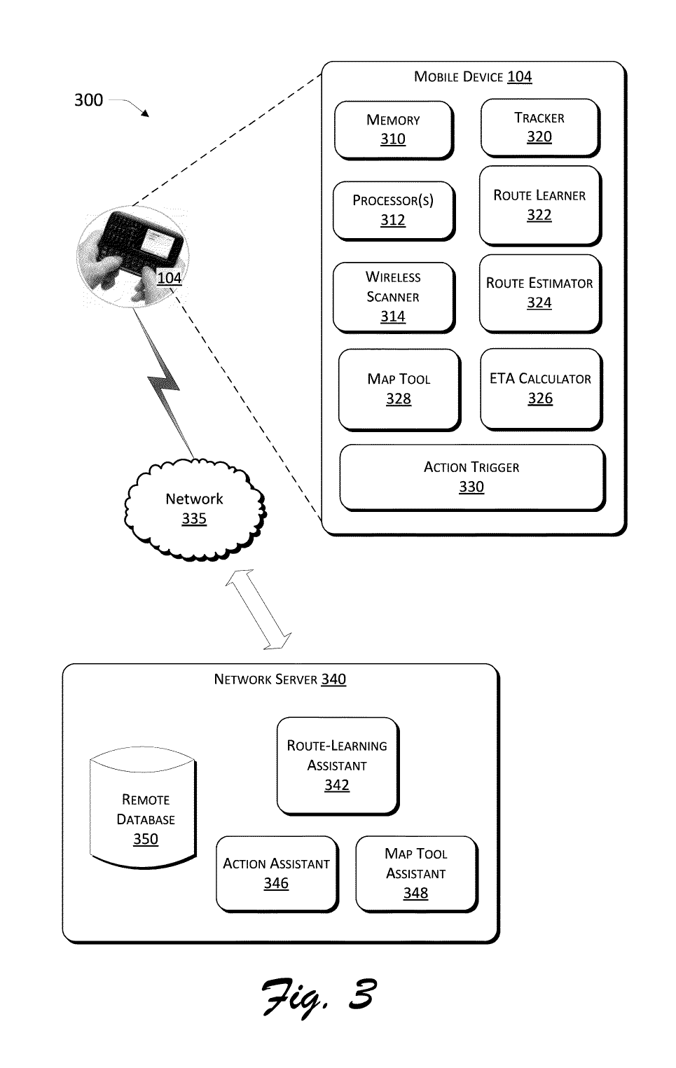

FIG. 3 illustrates example system 300 for implementing the technology described herein. The system 300 includes the mobile device 104, a network 335, and a network server 340.

The mobile device 104 includes a memory 310, one or more processor(s) 312, a wireless scanner 314, a tracker 320, a route learner 322, a route estimator 324, an ETA calculator 326, a map tool 328, and an action trigger 330. These functional components may be separate or some combination of hardware units. Alternatively, the components may be implemented, at least in part, in software and thus be stored in the memory 310 and executed by the processors 312.

The memory 310 may include its own local place/route database (akin to the to-be-described remote database 350). The local place/route database on the mobile device 104 stores the routes that have been learned by the device and the tracker 320 uses those route definitions in performing its tracking.

The wireless scanner 314 periodically scans for ambient IWS sources. The tracker 320 helps identify the encountered ambient IWS sources and store them in the memory 310. When it encounters an ambient IWS source, the wireless scanner 314 detects that ambient IWS source and identifies its unique identification (e.g., BSSID, MAC address, semantic name of “Home,” etc.).

Using a stream of encountered ambient IWS sources, the route learner 322 finds reoccurring patterns and learns routes. Based upon historical routes, the route estimator 324 estimates the present route and/or destination. Based upon that estimate and information about the historical routes, the ETA calculator 326 calculates an ETA.

The action trigger 330 performs or triggers the performance of a predetermined action based, at least in part, upon the route estimated or calculated ETA. For example, an automated text may be sent to another person when the mobile device 104 is located just a few minutes for the destination. A trigger for the action is often based, at least in part, upon the present ambient IWS source that the device 104 encounters while traveling.

Using a user interface (UI) on the device 104, a user may configure a triggering action using a configuration part of the action trigger 330. An action is defined to include the trigger (e.g., three minutes from a particular destination), automatic actions to be performed (e.g., sending a text message), and objects of such action (e.g., recipient of such a text message). Examples of other actions include sending an email, launching an application or program, enable a system function, or other so-called geo-fencing actions.

Of course, instead of triggering an action per se, the mobile device may display the ETA calculation to the user. This keeps the user informed of how long it will be until they reach their destination.

Alternatively, the map tool 328 may provide knowledge of geo-location of places (e.g., specific ambient IWS sources). Such knowledge may involve a database of WAP geo-locations. The map tool 328 may determine the geo-location of a logical place after the place has been recognized as a place and added to the model (e.g., route graph 200).

The network 335 may be a wired and/or wireless network. It may include the Internet infrastructure and it may be presented as the so-called “cloud.” The network 335 may include wired or wireless local area network, a cellular network, and/or the like. The network 335 links the mobile device 104 with the network server 340.

The network server 340 provides assistance to the mobile device 104 as part of one or more implementations of the technology described herein. In some implementations, the network 335 and network server 340 are not utilized. That is, the mobile device 104 performs the implementations described herein without assistance of the network 335 or network server 340. The network server 340 may be one or more actual servers.

The network server 340 includes a route-learning assistant 342, a route estimator assistant 344, an action assistant 346, a map tool assistant 348, and a route database 350. The route-learning assistant 342 may help the route learner 322 learn routes. This may be accomplished by off-loading data processing and data-transfer to off-peak times. For example, the most recent tracking data may be uploaded at night for data processing and reporting overnight.

Using the UI, the user may configure a triggering action via the action assistant 346. The action assistant 346 may be implemented, at least in part, as a website where a user may select triggers (e.g., three minutes from a particular destination), automatic actions to be performed (e.g., sending a text message), and objects of such action (e.g., recipient of such a text message).

Alternatively, the map tool assistant 348 may provide knowledge of geo-location of places (e.g., specific ambient IWS sources). Such knowledge may involve a database of WAP geo-locations. The map tool assistant 348 may determine the geo-location of a logical place after the place has been recognized as a place and added to the model (e.g., route graph 200). The consultation of the WAP database can occur at a time that is convenient to the mobile device 104. For example, it may happen at home, connected to free Wi-Fi connection and when charging. Also, the consultation might only need to occur once for each place.

The route database 350 stores a collection of route datasets collected from the mobile device 104 and other networked mobile devices. The route database 350 of a server may contain routes from various devices. That is, the route database 350 may be, at least in part, crowd-sourced. Based upon this collection of route datasets, the route-learning assistant 342 helps individual devices learn new, unknown, unrecognized, or incomplete routes. This database may be consulted for cross-referencing ambient IWS sources and routes traveled by various mobile devices.

### Route-Learning Operation

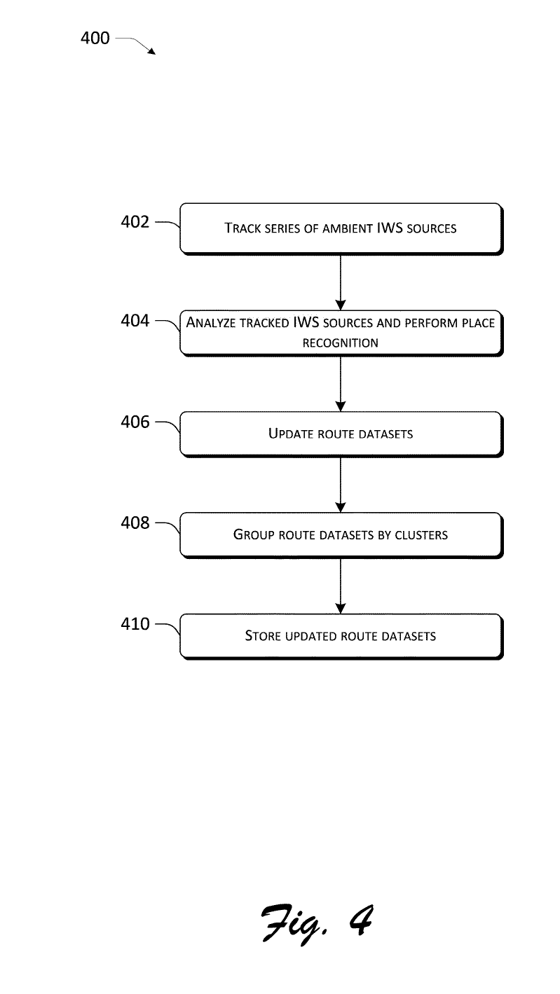

FIG. 4 illustrates an example process 400 for implementing, at least in part, the technology described herein. In particular, process 400 depicts a route-learning operation of the mobile device 104.

At 402, the mobile device 104 encounters a series of ambient IWS sources. the mobile device 104 periodically scans for ambient IWS sources. The tracker 320 detects, identifies, and records encountered ambient IWS sources.

Each detected and identified ambient IWS source is tracked as part of a series of such sources. If the series has differing ambient IWS sources, then the mobile device 104 is traveling. The pattern of differing ambient IWS sources may be a route. As used herein, a route has a start and end place as well as a set of ambient IWS sources that have been previously encountered along the route. Examples of such routes are illustrated in route datasets 212, 214, 222, and 224.

This route-learning process 400 is incremental and can be run occasionally (e.g., nightly) to keep the route database up to date. In addition, timing information about the route is tracked and stored in association with the route datasets. For example, the mobile device 104 tracks how many times the route has been traveled and the average time the trips have taken.

In addition, the mobile device 104 tracks how many times each IWS source has been observed on the known route and what point (by time offset from start) that each IWS source was observed.

In one or more implementations, the information for a route between places <start> and <end> with IWS identification seen at the beginning (e.g., IWSID₁) and another IWS identification seen in the middle (e.g., IWSID₂) would be represented by the example format of the route dataset:
Rₛₜₐᵣₜ_{_{→}}_{end}=(Pₛₜₐᵣₜ, P_{end}, T_{avg} [Tₛ₁, Tₑ₁, {(IWSID₁₁, X₁₁, P₁₁, T_{fs11}, T_{fe11}), (WISID₁₂, X₁₂, P₁₂, T_{fs12}, T_{fe12}) . . . }], [Tₛ₂, Tₑ₂, {(IWSID₂₁, X₂₁, P₂₁, T_{fs21}, T_{fe21}), (IWSID₂₂, X₂₂, P₂₂, T_{fs22}, T_{fe22}) . . . }], . . . )
   where Tₛ₁ and Tₑ₁ are the start time and end time respectively for the first trip, T_{avg} is the average total time from start to end of the trips, Pᵢ₁ is the percentage of the route that has been traversed when IWSIDᵢ is observed on trip 1, and T_{fsi1} is the time after the start when IWSIDᵢ is observed on trip 1. That is, T_{fs1} is the offset time from the start. Tₑₛᵢ₁ is the time after the end of the trip when IWSIDᵢ is observed on trip 1.

Since logs of the tracked IWS sources contain both the time of departure and time of arrival, the mobile device 104 computes, for each ambient IWS source of a route, how far into the trip it was seen and how far from the end. For example, IWS source “X” was seen thirty seconds after leaving Work, which was four hundred twenty seconds before arriving at Home.

Furthermore, the mobile device 104 accumulates this information over a number of traversals of the route. In one or more implementations, the mobile device 104 stores this new timing information in the route representation for each IWS source:
IWSID₁+{(time-from-departure, time-to-destination), (time-from-departure, time-to-destination), . . . }

In this set of timing information, each pair captures the timing of the observation of that IWS source during one traversal of the route. The size of this set can be bounded by merging similar pairs and by removing pairs which represent times which have not been seen in a long time. This can occur for example if a construction project increases the duration of a route. While construction is ongoing, the pairs representing the longer duration are valid estimates. After construction has been completed, the longer times are no longer observed and after some amount of time the system will purge them from the system. It should be noted that in order to perform this type of purging operation the system (e.g., system 300) maintains a timestamp for each of the pairs representing the last time that this AP was observed with this timing information.

At 404, the mobile device 104 analyzes the series of encountered ambient IWS sources (e.g., w₁, w₂, w₃, . . . wₙ) to determine place recognition. The route learner 322 performs place recognition to designate a single IWS source or a collection of sources as a place. For example, a place may be designated “home” or “work” or some other unique label. It then removes the sequence of IWS observations that represent the place visit and replaces them in the series with a token to represent the time spent at the place. For example, consider the IWS subsequence . . . w₄, w₃, w₆, w₆, w₆, w₆, w₆, w₃ . . . . If place P₂₇ was known to contain IWS w₆ the place recognizer would recognize the series of observations of w₆ as a visit to place P₂₇.

Accordingly, the mobile device 104 substitutes the series of IWS observations (in this case) with the token ‘P₂₇’ and as a result the subsequence becomes: . . . w₄, w₃, P₂₇, w₃ . . . . In this way, the full series of IWS observations is reduces to subsequences of IWS observations that represent periods of movement, bracketed by token representing the place where the movement started and where it ended. For a particular implementation, a segment of the series that corresponds to place visits is replaced with tokens representing the place:
(P₀, wᵢ₊₁, wᵢ₊₂, wᵢ₊₃w, . . . , P₁, wⱼ₊₁, wⱼ₊₂, wⱼ₊₃, . . . , P₂ . . . )
   where P₀, P₁, and P₂ are place tokens.

The remaining segments of series represent the times when routes were travelled and the place tokens before and after the segments are the start and end of the trip.

At 406, the mobile device 104 updates the route datasets. For each segment of the series of tracked IWS sources between, for example, places a and b, the route learner 322 does the following:
If the route Rₐ_{_{→}}_{b} does not exist, create it. That is, if no route dataset exists for the route between a and b, then generate a new route dataset.
Otherwise, if that route does exists, then update that route dataset by incrementing the number of trips and adjusting the average trip time based on trip count and the latest traversal time using the first and last Wi-Fi scan time in the segment.
For each observed IWSID in the segment: add the IWSID to the set for Rₐ_{_{→}}_{b} dataset if it is not already included and update the count and weighted percentage based on its first observation in the segment.

At 408, the route datasets are updated based upon the timing information gathered. Indeed, at this point, the datasets may be grouped and categorized based upon clustered data, such as time of travel of the route.

Many factors can affect the timing of trips along a particular known route. Examples of such trip-timing affecting factors include: weather conditions (e.g., snow, wind, etc.), time of day (e.g., lunch time), day of the week (weekday, weekend, etc.), traffic conditions (rush hour, accident, constructions), mode of travel (e.g., walking, biking, or riding in a car, etc.) and the like.

The effect of these factors is incorporated into timing of multiple trips under those conditions. The route datasets for a particular known route may be grouped according to clusters of similarly timed routes. For example, presume that seventeen datasets are clustered about seven minutes and five datasets are clustered about an hour. Each of these groups are presumed to represent the user traveling via different modes of transport. Perhaps the seven-minute trips are driving while the hour-long trip along the same route is walking. The grouping route datasets may be used when calculating the ETA while a mobile device is traveling.

At 408, the results of the update are stored in the memory 310 of the mobile device 104. Such results may be uploaded via the network 335 to the network server 340.

### Operation for Predicting Destination and Calculating ETA

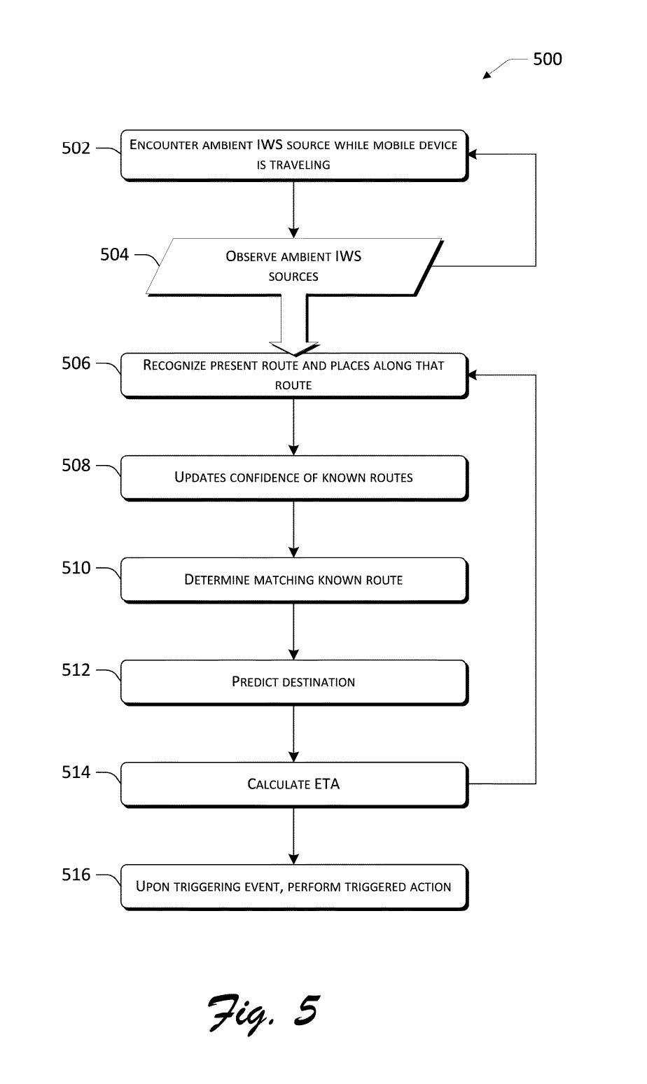

FIG. 5 illustrates an example process 500 for implementing, at least in part, the technology described herein. In particular, process 500 depicts a route-estimation operation of the mobile device 104. When the user travels along a known route, the process 500 also predicts destination and calculates ETA. This process 500 may be operating at all times and thus maintains an estimate of the user's place, route, destination, and ETA on an on-going basis.

The process 500 is evidence-based using each Wi-Fi scan to either increase or decrease its confidence in each place and/or route in the user's location model (e.g., route graph 200). The user's state is a combination of places and routes whose confidence level exceeds a threshold and thus represent the most likely location of the user.

At 502, the mobile device 104 encounters an ambient IWS source. The mobile device 104 periodically scans for ambient IWS sources while the device is traveling. The mobile device 104 detects and identifies the ambient IWS sources that it encounters along its present route.

At 504, the mobile device 104 observes the ambient IWS sources that it encounters along its present route. Operation 504 loops back to operation 502 to repeat the scanning and observing actions while the mobile device 104 traverses a route. While doing so, each observation of an identified ambient IWS source is added to the sequence of past observations. This creates a time-ordered series of the IWSs that have been observed by the device. If the series has differing ambient IWS sources, then the mobile device 104 is traveling. The pattern of differing ambient IWS sources may be a route. As used herein, the route has a start and end place as well as a set of ambient IWS sources that have been previously encountered along the route. Examples of such routes are illustrated in route datasets 212, 214, 222, and 224. Operations 502 and 504 may be performed by the wireless scanner 314 and/or the tracker 320 of the mobile device.

As depicted in FIG. 5, operations 502 and 504 operate in a continuous loop as long as the mobile device 104 is moving. Likewise, operations 502-514 operate in a continuous loop as long as the mobile device 104 is moving. A wide arrow is shown between operations 504 to 506. This wide arrow represents a link between these two separate but related continuous loops. The second loop (i.e., operations 502-514) uses information about tracked ambient IWS sources to perform its actions. Indeed, the most recently encountered ambient IWS sources (or more recent one) are used by this second loop.

At 506, the mobile device 104 attempts to recognize the present places and route. The results of this recognition attempt may result in one of several determinations:
The mobile device 104 is either in place Pᵢ or traveling a route in a set {R₁, R₂, . . . Rₙ};
The mobile device 104 is stationary and located in a known place Pᵢ;
The mobile device 104 is traveling route in set {R₁, R₂, . . . Rₙ};
The mobile device 104 is in an unknown place; or
The mobile device 104 is traveling an unknown route.

These determinations may also be called user “states.” Using the route/place information learned from past travels (which is stored in the memory 310), the route estimator 324 can recognize when a route is being traveled and predict the destination and ETA. Operation 506 may be performed by the route estimator 324.

At 508, the mobile device 104 updates a “confidence” level with each of one or more known routes (e.g., previously recognized routes). This is an evidence-based confidence adjustment. That is, the degree of confidence adjustment for a given route or place depends upon how much evidence found in the one or more portions of the encountered series of ambient IWS sources.

In effect, with each ambient IWS source encountered, the mobile device 104 obtains evidence to adjust the confidence level with one or more of the previously known places/locations or routes. If the encountered ambient IWS source matches a known route or place, the confidence in the matching route or place increases. The amount of the confidence increase depends on the user's recent history. For example, if the user has recently departed place, such as Home 110, the observations of encountered ambient IWS sources in routes with a start of Home will increase confidence more than those that do not.

Similarly, if a user's state contains routes with the destination, such as Work 122, the observations of encountered ambient IWS sources from Work itself will cause confidence of our arrival at Work to rise quickly. Operation 508 may be performed by the route estimator 324.

At 510, the mobile device 104 determines which of one or more known routes mostly likely matches the present route. In the absence of any ambient IWS source matches during the recognition operation 504, the confidence in all known routes and places decreases. If this continues, the user's state will ultimately settle on “unknown place” or “unknown route” based on the stability of the Wi-Fi signals. Evidence for routes and evidence for places is processed in concurrently or at least nearly so since a particular ambient IWS source can be part of a place and one or more routes (e.g., the restaurant 128 on the way Home 110 and to the café ' 124). The amount of the confidence increase is based on the user's history as represented by their place and route graph.

Confidence in routes or places that are predicted by the model increases at a faster rate than confidence in places or routes that are not predicted by the model. For example, if the user is on a route from Home 110 to the café 124, and the device 104 observes an ambient IWS source associated with the café 124, confidence in the place café increases quickly. On the other hand, if the device 104 observes an ambient IWS source associated with place Church 120 and we were not on the route to Church, confidence in place Church increases slowly.

The mobile device 104 determines which routes or places are most likely matches when their confidence level rises above a designated or calculated confidence threshold. Those that drop below a threshold are removed from consideration. These thresholds may be assigned based upon user state. Of course, the user can be in at most one place at a time. So, if a place rises above the threshold for state inclusion, any other place is immediately removed. Operation 510 may be performed by the route estimator 324.

At 512, the mobile device 104 predicts the destination based upon the known route as determined by operation 510) and information tracked about the present route. Operation 512 may be performed by the ETA calculator 326.

At 514, the mobile device 104 calculates an ETA based upon the known route as determined by operation 510) and information tracked about the present route. The determined route is the route with the highest degree of confidence in operation 510. Operation 514 may be performed by the ETA calculator 326

Generally, the mobile device 104 calculates ETA based upon timing information from the last known ambient IWS source on the present route and the passage of time since that IWS source was encountered. The initial ETA is established when the mobile device 104 first encounters the first known ambient IWS source on the present route.

The mobile device 104 calculates ETA between encountering known ambient IWS sources on the present route. It does this by decreasing the time-to-arrival by one second for each second that passes since that the known ambient IWS source was encountered. In this way, in the absence of encountering known ambient IWS source, the mobile device 104 assumes the user is continuing to make progress towards the predicted destination of the determined route.

When the mobile device 104 encounters a known ambient IWS source of the determined route, the mobile device utilizes the timing information associated with that known IWS source to update the ETA at the predicted destination. The encounter with the known IWS source acts as an indication of how far the mobile device 104 has traveled towards the predicted destination of the determined route. For example, if an IWS source labeled “X13” is always seen ninety seconds from the destination, then the time-to-arrival can be changed to ninety seconds when X13 has been encountered.

However, for a number of reasons (e.g., traffic, mode of transport, etc.), the time X13 is seen both from the departing place as well as before arrival at the destination can vary. As previously discussed with regard to FIG. 4, the timing information associated with each IWS source on a route is in the route representation as a collection of (time-from-departure, time-to-destination) pairs. To account for this variation, the mobile device 104 updates the time-to-arrival using a weighted average of the past timing pairs for the particular IWS source of this determined route. The weighting is based on how closely the time-from-departure in the historical timing data matches the traversal time of the present route.

For example, suppose Isabel has an eight-minute commute by car, but on sunny days she walks and it takes an hour. Occasionally, she comes come to work on Sundays, and those times she always drives since it only takes four minutes due to lack of traffic. In this example, a particular IWS source labeled IWS-4 is usually encountered about three-quarters of the way into the commute. The place/route model may have many records of IWS-4 collected over the recent weeks. Most of those records show IWS-4 being encountered six minutes after leaving Home and two minutes before arriving at Work. Others records show encounters during her walks at forty minutes into the trip and twenty minutes from arrival. A few records show the times of the shorter Sunday drives at three minutes after departure and one minute before arrival.

Table A below illustrates this example situation:

TABLE A

| | | IWS- | IWS- | IWS- | IWS- | IWS- | |
|---|---|---|---|---|---|---|---|
| | Home | 1 | 2 | 3 | 4 | 5 | Work |
| Normal | \\ | 1, 6 | 3, 5 | 5, 3 | 6, 2 | 7, 1 | // |
| Com- | \\ | 1, 7 | 4, 5 | 5, 2 | 6, 3 | . . . | // |
| mute | \\ | 1, 5 | 3, 4 | 5, 4 | . . . | . . . | // |
| Sunday | \\ | 1, 3 | 2, 3 | 3, 3 | 3, 1 | 4, 0 | // |
| Com- | \\ | 1, 4 | . . . | 2, 3 | . . . | . . . | // |
| mute | | | | | | | |
| Walk- | \\ | 10, 50 | 20, 40 | 30, 30 | 40, 20 | 50, 10 | // |
| ing | | | | | | | |

The rows of Table A represent trips of the same route and the columns represent timing data about the IWS sources collected along those routes. The rows listed here may be called a collection of multiple trips along the same route.

Table A shows five IWS sources that are encountered by Isabel on her way to Work from Home. Many of the boxes of Table A include a set of number pairs. These are timing pairs (time-from-source, time-to-destination) for each of the IWS sources and for each route learned by the mobile device 104. In the table, the routes are grouped according to the three commute situations described in the example. Each of these groups may be called an affinity group herein.

For this example, assume that while Isabel travels to work, the mobile device 104 IWS-4 forty-two minutes into the route traversal. The most likely scenario is that Isabel was walking to work and thus she is about twenty minutes from Work. Accordingly, this approach weighs heavily towards encounters that closely match the time-from-departure for an IWS source to determine the mode of transport. The following quadratic weighting function may be utilized:
Time=Normalized(Sum(model_sample_time_to_destination/(actual_time_since_departure−model_sample_time_since_departure)̂2))
   This quadratic weighting function serves the purpose of approximating the creation and selection of the affinity groups. In this way, we do not need to actually construct the affinity groups or select them while tracking. All of this is done by this weighting function, which will much more heavily include the arrival estimates of past trips, which most closely match the current trip's time-since-departure.

This approach for selecting the estimated time-to-destination from among the previously observed values is not only effective in dealing with different modes of travel, but also allows us to handle variations in travel time due to varying traffic conditions.

Suppose that the bulk of Hope's commute is vulnerable to traffic conditions, but the last quarter mile is always fast since it is along a lonely access road. This approach will learn that. The mobile device 104 will learn over time that progress along the bulk of Hope's route is varied, and it will keep a full distribution of those times. The mobile device 104 will select the estimate based on time from the source. However, the mobile device 104 will also learn that regardless of how long it takes to get there, the last quarter mile nearly always take a hundred seconds. In this way, this approach is far better than a simple rate-scaling or other linear approximation.

In some implementations, each encounter with a known IWS source does not reset the current time-to-arrival estimate. To provide smoothness to the ETA calculation, the mobile device 104 may perform arithmetic smoothing in which each encounter with a known IWS source determines twenty-five percent of the new estimate while the current estimate contributes seventy-five percent.

At 516, the mobile device 104 may display the ETA to the user. Also, it may trigger or perform an action based upon the determined route. The user may have configured the mobile device to perform an action at a certain place or based upon the ETA of a given route. For example, when a user leaves Work 122 and starts Home 110, the mobile device might send a message to her husband once the route from Work to Home is determined. That message may actually include a calculated ETA. Operation 516 may be performed by the action trigger 330

In some implementations, ambient IWS sources that are considered close to a known place may be ignored. For example, the ambient IWS source of the next-door neighbor may be culled from the route datasets involving the Home 110 so that they do not cause a false conclusion that the user is starting down a route when she is in fact staying at the place.

Also, in the case that a route and its reverse (Home->Work and Work->Home) are both above the threshold for inclusion in the user's state, the process 500 only include the one with higher confidence. This occurs because both routes will share many common ambient IWS sources.

Further, in some implementations, progress within a route is estimated by seeing how far into past trips the matching ambient IWS sources were encountered. For example, an ambient IWS source might match both of the current routes, P1->P5 and P1->P8, in the user's set, one usually encountered 25% of the way through the trip, the other 80%. The process 500 may estimate that the user is either 25% of the way to P5 or 80% of the way to P5. By scaling this estimate by the average trip time, the process may then make an estimate of ETA.

A user's routes and places as well as the Wi-Fi infrastructure will change over time. To accommodate for this, some implementation may aging out training data over time. This could be accomplished in, for example, two ways: One is to occasionally retraining from scratch using only recent (e.g., within the last six months) Wi-Fi traces. Alternately, a ‘time to live’ field could be used to the route and place data allowing incremental aging of the training data.

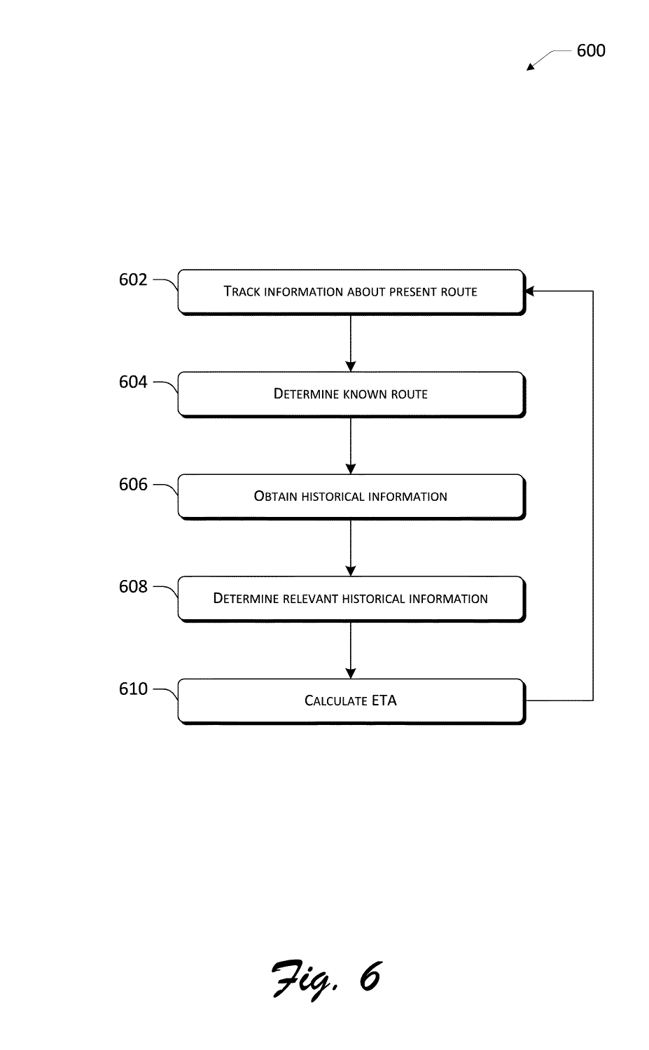

FIG. 6 illustrates another example process 600 for implementing, at least in part, the technology described herein. In particular, process 600 depicts ETA calculation operations. This process 600 may be operating at all times and thus maintains an estimate of the destination and ETA on an on-going basis.

At 602, the mobile device 104 tracks information about a present route that a mobile device is traveling, wherein the tracked information about the present route includes timing of encounters with one or more ambient identifiable wireless signal (IWS) sources of the present route.

At 604, the mobile device 104 determines which known route from amongst a plurality of known routes matches the present route that a mobile device is traveling.

At 606, the mobile device 104 obtains historical information about a collection of multiple trips along the determined route, wherein the historical information about the collection of multiple trips along the determined route includes timing of encounters with one or more ambient identifiable wireless signal (IWS) sources of the determined route.

At 608, the mobile device 104 determines relevant historical information. The device groups multiple trips into affinity groups of trips based upon clusters of trip with similar timing of the encounters with the one or more ambient IWS sources of the determined route. The device determines which affinity group of trips has timing of encounters of the determined route is closest to the timing of encounters of the present route and the device selects the determined affinity group,

At 610, the mobile device 104 calculates the estimated time of arrival (ETA) at a likely destination of the present route. The ETA calculation is based upon tracked information about the present route and the historical information from the collection of multiple trips along the determined known route. More precisely, the calculation is based upon the historical information of the selected affinity group. That group effectively becomes the collection of multiple trips from which the historical information is obtained by the obtaining and upon which the ETA is calculated.

### Example Computing Device

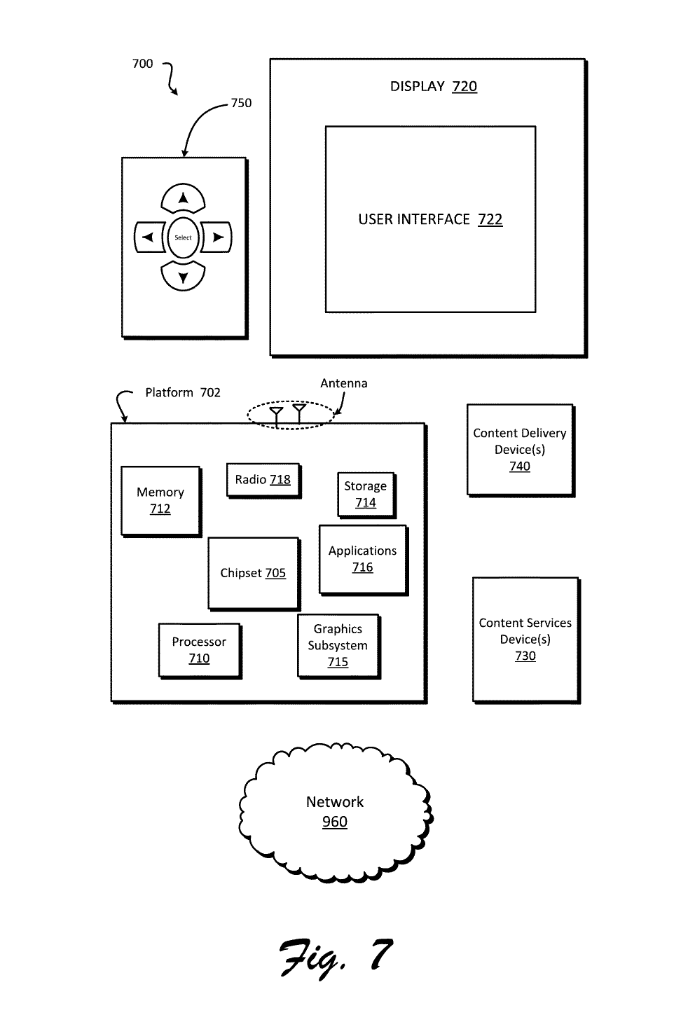

FIG. 7 illustrates an example system 700 that may implement, at least in part, the technologies described herein. In various implementations, system 700 is a media system, although system 700 is not limited to this context. For example, system 700 can be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet, or smart television), mobile internet device (MID), messaging device, data communication device, and so forth.

In various implementations, system 700 includes a platform 702 coupled to a display 720. Platform 702 receives content from devices such as content services device 730, content delivery device 740, or other similar content sources. A navigation controller 750 including one or more navigation features may be used to interact with, for example, platform 702 and/or display 720.

In various implementations, platform 702 includes any combination of a chipset 705, a processor 710, memory 712, storage 714, a graphics subsystem 715, applications 716 and/or radio 718. Chipset 705 provides intercommunication among processor 710, memory 712, storage 714, graphics subsystem 715, application 716, and/or radio 718. For example, chipset 705 can include a storage adapter (not depicted) capable of providing intercommunication with storage 714.

Processor 710 may be implemented as a complex instruction set computer (CISC) or reduced instruction set computer (RISC) processors, x86 instruction set compatible processors, multicore, or any other microprocessor or central processing unit (CPU). In various implementations, processor 710 may be dual-core processors, dual-core mobile processors, and so forth.

Memory 712 may be implemented as a volatile memory device such as, but not limited to, a random access memory (RAM), dynamic random access memory (DRAM), or static RAM (SRAM).

Storage 714 may be implemented as a nonvolatile storage device such as, but not limited to, a magnetic disk drive, optical disk drive, tape drive, an internal storage device, an attached storage device, flash memory, battery backed-up synchronous DRAM (SDRAM), and/or a network accessible storage device. In various implementations storage 714 includes technology to increase the storage performance-enhanced protection for valuable digital media when multiple hard drives are included.

Graphics subsystem 715 processes of images such as still or video for display. Graphics subsystem 715 can be a graphics processing unit (GPU) or a visual processing unit (VPU), for example. An analog or digital interface may be used to communicatively couple the graphics subsystem 715 and the display 720. For example, the interface can be a high-definition multimedia interface, display port, wireless high definition media interface (HDMI), and/or wireless HD-compliant techniques. Graphics subsystem 715 may be integrated into processor 710 or chipset 705. In some implementations graphics subsystem 715 may be a stand-alone card communicatively coupled to chipset 705.

The graphics and/or video processing techniques described herein are implemented in various hardware architectures. For example, graphics and/or video functionality may be integrated within a chipset. Alternatively, a discrete graphics and/or a video processor may be used. As still another implementation, the graphics and/or video functions may be provided by a general-purpose processor, including a multicore processor. In further embodiments, the functions may be implemented in a consumer electronics device.

Radio 718 may include one or more radios capable of transmitting and receiving signals using various suitable wireless communications techniques. Such techniques involve communications across one or more wireless networks. Example wireless networks include, but are not limited to, wireless local area networks (WLANs), wireless personal area networks (WPANs), wireless metropolitan area network (WMANs), cellular networks, and satellite networks. In communicating across such networks, radio 718 operates in accordance with one or more applicable standards in any version.

In various implementations, display 720 includes any television-type monitor or display. Display 720 may include, for example, a computer display screen, touch-screen display, video monitor, television-like device, and/or a television. Display 720 can be digital and/or analog. In various implementations, display 720 may be a holographic display. In addition, display 720 may be a transparent surface that receives a visual projection. Such projections convey various forms of information, images, and/or objects. For example, such projections may be a visual overlay for a mobile augmented reality (MAR) application. Under the control of one or more software applications 716, platform 702 can display user interface 722 on display 720.

In various implementations, content services device(s) 730 may be hosted by any national, international, and/or independent service and thus accessible to platform 702 via the Internet. Content services device(s) 730 may be coupled to platform 702 and/or to display 720. Platform 702 and/or content services device(s) 730 may be coupled to a network 760 to communicate media information to and from the network 760. Content delivery device(s) 740 also may be coupled to platform 702 and/or to display 720.

In various implementations, content services device(s) 730 include a cable television box, personal computer, network, telephone, Internet-enabled devices, appliances capable of delivering digital information and/or content, and any other similar device capable of unidirectionally or bidirectionally communicating content between content providers and platform 702 and/display 720, via network 760 or directly. The content can be communicated unidirectionally and/or bidirectionally to and from any one of the components in system 700 and a content provider via a network 760. Examples of content include any media information including, for example, video, music, medical and gaming information, and so forth.

Content services device(s) 730 receive content such as cable television programming including media information, digital information, and/or other content. Examples of content providers include any cable or satellite television or radio or Internet content providers. The provided examples are not meant to limit implementations in accordance with the present disclosure in any way.

In various implementations platform 702 may receive control signals from navigation controller 750 having one or more navigation features. The navigation features of controller 750 may be used to interact with user interface 722, for example. In some embodiments, navigation controller 750 may be a pointing device such as a computer hardware component, specifically a human interface device, that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 can be replicated on a display (e.g., display 720) by movements of a pointer, cursor, focus ring, or other visual indicators displayed on the display. For example, under the control of software applications 716, the navigation features located on navigation controller 750 can be mapped to virtual navigation features displayed on user interface 722. In some embodiments, controller 750 may not be a separate component but may be integrated into platform 702 and/or display 720. The present disclosure, however, is not limited to the elements or in the context shown or described herein.

In various implementations, drivers (not shown) include technology to enable users to instantly turn on and off platform 702 like a television with the touch of a button after initial boot up, when enabled. Program logic allows platform 702 to stream content to media adaptors or other content services device(s) 730 or content delivery device(s) 740 even when the platform is turned off. In addition, chipset 705 includes hardware and/or software support for 5.1 surround sound audio and/or high definition 5.1 surround sound audio, for example. Drivers may include a graphics driver for integrated graphics platforms. In some embodiments the graphics driver may comprise a peripheral component interconnect (PCI) express graphics card.

In various implementations any one or more of the components shown in system 700 can be integrated. For example, platform 702 and content services device(s) 730 can be integrated, or platform 702 and content delivery device(s) 740 can be integrated, or platform 702, content services device(s) 730, and content delivery device(s) 740 can be integrated. In various embodiments, platform 702 and display 720 can be an integrated unit. Display 720 and content service device(s) 730 can be integrated, or display 720 and content delivery device(s) 740 can be integrated. These examples are not meant to limit the present disclosure.

In various embodiments system 700 can be implemented as a wireless system, a wired system, or a combination of both. When implemented as a wireless system, system 700 can include components and interfaces suitable for communicating over a wireless shared media, such as one or more antennae, transmitters, receivers, transceivers, amplifiers, filters, control logic, and so forth. An example of wireless shared media includes portions of a wireless spectrum, such as the RF spectrum. When implemented as a wired system, system 700 can include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media can include a wire, cable, metal leads, printed circuit board (PCB), backplane, switch fabric, semiconductor material, twisted-pair wire, coaxial cable, fiber optics, and others.

Platform 702 can establish one or more logical or physical channels to communicate information. The information includes media information and control information. Media information refers to any data representing content meant for a user. Examples of content include data from a voice conversation, videoconference, streaming video, electronic mail (“e-mail”) message, voice-mail message, alphanumeric symbols, graphics, image, video, text, and so on. Data from a voice conversation can be, for instance, speech information, silence periods, background noise, comfort noise, tones, and other similar items. Control information refers to any data representing commands, instructions, or control words meant for an automated system. For example, control information can be used to route media information through a system, or instruct a node to process the media information in a predetermined manner. The embodiments, however, are not limited to the elements or in the context shown or described in FIG. 7.

As described above, system 700 can be embodied in varying physical styles or form factors. FIG. 7 illustrates implementations of a small form-factor device 700 in which system 700 can be embodied. In embodiments, for example, device 700 can be implemented as a mobile computing device having wireless capabilities. A mobile computing device may refer to any device having a processing system and a mobile power source or supply, such as one or more batteries.

Examples of a mobile computing device, in addition to those already mentioned, also may include computers that are arranged to be worn by a person, such as a wrist computer, finger computer, ring computer, eyeglass computer, belt-clip computer, arm-band computer, shoe computers, clothing computers, and other wearable computers. In various embodiments, a mobile computing device can be implemented as a smart phone capable of executing computer applications, as well as voice communications and/or data communications. Although some embodiments can be described with a mobile computing device, other embodiments can be implemented using other wireless mobile computing devices as well. The embodiments are not limited in this context.

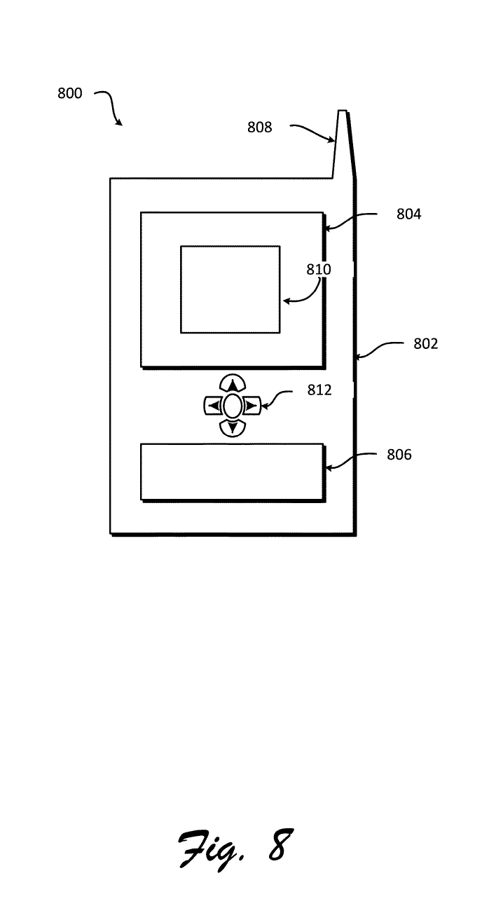

As shown in FIG. 8, device 800 includes a housing 802, a display 804, an I/O device 806, and an antenna 808. Device 800 also includes navigation features 812. Display 804 includes any suitable display unit for displaying information appropriate for a mobile computing device. I/O device 806 includes any suitable I/O device for entering information into a mobile computing device. Examples for I/O device 806 include an alphanumeric keyboard, a numeric keypad, a touch pad, input keys, buttons, switches, rocker switches, microphones, speakers, voice recognition device and software, and others. Information also can be entered into device 800 by way of microphone (not shown). Such information is digitized by a voice recognition device (not shown). The embodiments are not limited in this context.

Various embodiments can be implemented using hardware elements, software elements, or a combination of both. Examples of hardware elements include processors, microprocessors, circuits, circuit elements (e.g., transistors, resistors, capacitors, inductors, etc.), integrated circuits, application specific integrated circuits (ASIC), programmable logic devices (PLD), digital signal processors (DSP), field programmable gate array (FPGA), logic gates, registers, semiconductor device, chips, microchips, chip sets, and more. Examples of software include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements varies in accordance with any number of factors, such as desired computational rate, power levels, heat tolerances, processing cycle budget, input data rates, output data rates, memory resources, data bus speeds, and other design or performance constraints.

One or more aspects of at least one embodiment can be implemented by representative instructions stored on a machine-readable medium that represents various logic within the processor, which when read by a machine causes the machine to fabricate logic to perform the techniques described herein. Such representations, known as “IP cores” can be stored on a tangible, machine-readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations, and data stores are somewhat arbitrary, and particular operations are demonstrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

### Additional and Alternative Implementation Notes

Herein, a mobile device may be called a wireless device, handset, handheld device, or the like. In general, a mobile device is a small, hand-held, portable computing device that typically has a display screen and some user input mechanism (e.g., touch screen or keyboard). Often they weigh less than two pounds. Often, they are equipped with wireless communications capabilities, such as Wi-Fi, Bluetooth, and cellular. Examples of implementations of a mobile device include a smartphone, a tablet computer, a feature phone, a personal digital assistant (PDA), any wireless-enabled wearable devices, laptop computers, netbook computers, or other so-called handheld devices or computers.

In the above description of exemplary implementations, for purposes of explanation, specific numbers, materials configurations, and other details are set forth in order to better explain the present invention, as claimed. However, it will be apparent to one skilled in the art that the claimed invention may be practiced using different details than the exemplary ones described herein. In other instances, well-known features are omitted or simplified to clarify the description of the exemplary implementations.

The inventor intends the described exemplary implementations to be primarily examples. The inventor does not intend these exemplary implementations to limit the scope of the appended claims. Rather, the inventor has contemplated that the claimed invention might also be embodied and implemented in other ways, in conjunction with other present or future technologies.

Moreover, the word “exemplary” is used herein to mean serving as an example, instance, or illustration. Any aspect or design described herein as exemplary is not necessarily to be construed as preferred or advantageous over other aspects or designs. Rather, use of the word “exemplary” is intended to present concepts and techniques in a concrete fashion. The term “technology,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

One or more embodiments described herein may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “computer-readable media” includes computer-storage media. For example, computer-storage media may include, but are not limited to, magnetic storage devices (e.g., hard disk, floppy disk, and magnetic strips), optical disks (e.g., compact disk [CD] and digital versatile disk [DVD]), smart cards, flash memory devices (e.g., thumb drive, stick, key drive, and SD cards), and volatile and nonvolatile memory (e.g., RAM and ROM).

What is claimed is:

1. A mobile device, comprising:
a tracker configured to track information about a present route that a mobile device is traveling;
a route estimator configured to determine which known route from amongst a plurality of known routes matches the present route that a mobile device is traveling;
an ETA calculator configured to:
obtain historical information about a collection of multiple trips along the determined route;
calculate estimated time of arrival (ETA) at a likely destination of the present route, based upon tracked information about the present route and the historical information from the collection of multiple trips along the determined known route.

2. A mobile device according to claim 1, wherein the tracked information about the present route includes timing of encounters with one or more ambient identifiable wireless signal (IWS) sources of the present route.

3. A mobile device according to claim 1, wherein the tracked information about the present route includes timing from an encounter with a first ambient identifiable wireless signal (IWS) source of the present route and a last ambient IWS source of that present route.

4. A mobile device according to claim 1, wherein the historical information about the collection of multiple trips along the determined route includes timing of encounters with one or more ambient identifiable wireless signal (IWS) sources of the determined route.

5. A mobile device according to claim 1, wherein:
the tracked information about the present route includes timing of encounters with one or more ambient identifiable wireless signal (IWS) sources of the present route;
the historical information about multiple trips along the determined route includes timing of encounters with one or more ambient IWS sources of the determined route;
the ETA calculator being further configured to:
group multiple trips into affinity groups of trips based upon clusters of trip with similar timing of the encounters with the one or more ambient IWS sources of the determined route;
determine which affinity group of trips has timing of encounters of the determined route is closest to the timing of encounters of the present route; and
select the determined affinity group,
wherein the selected affinity group is the collection of multiple trips from which the historical information is obtained by the obtaining and from which the ETA calculating is based.

6. A mobile device according to claim 1, wherein the ETA calculation is based upon timing information of the tracked information about the present route and timing information the historical information from the collection of multiple trips along the determined known route.

7. A mobile device according to claim 1, wherein the ETA calculator being further configured to match timing information of the tracked information about the present route to a timing information of the historical information from the collection of multiple trips along the determined known route, wherein that collection has timing formation similar to that of the tracked information about the present route.

8. A mobile device according to claim 1, wherein:
the tracker is further configured to encounter one or more ambient identifiable wireless signal (IWS) sources of the present route;
the route estimator further configured to determine that the one or more of encountered ambient IWS sources match at least a portion of the series of encountered ambient IWS sources of the determined route;
the ETA calculator is further configured to trigger the calculating in response to a determination of a match, wherein the calculating is based upon the matching one or more of encountered ambient IWS sources.

9. One or more computer-readable media storing processor-executable instructions that when executed cause one or more processors to perform operations comprising:
tracking information about a present route that a mobile device is traveling;
determining which known route from amongst a plurality of known routes matches the present route that a mobile device is traveling;
obtaining historical information about a collection of multiple trips along the determined route;
based upon tracked information about the present route and the historical information from the collection of multiple trips along the determined known route, calculating estimated time of arrival (ETA) at a likely destination of the present route.

10. One or more computer-readable media according to claim 9, wherein the tracked information about the present route includes timing of encounters with one or more ambient identifiable wireless signal (IWS) sources of the present route.

11. One or more computer-readable media according to claim 9, wherein the historical information about the collection of multiple trips along the determined route includes timing of encounters with one or more ambient identifiable wireless signal (IWS) sources of the determined route.

12. One or more computer-readable media according to claim 9, wherein:
the tracked information about the present route includes timing of encounters with one or more ambient identifiable wireless signal (IWS) sources of the present route;
the historical information about multiple trips along the determined route includes timing of encounters with one or more ambient IWS sources of the determined route;
the operations further comprise:
grouping multiple trips into affinity groups of trips based upon clusters of trip with similar timing of the encounters with the one or more ambient IWS sources of the determined route;
determining which affinity group of trips has timing of encounters of the determined route is closest to the timing of encounters of the present route; and
selecting the determined affinity group,
wherein the selected affinity group is the collection of multiple trips from which the historical information is obtained by the obtaining and from which the ETA calculating is based.

13. One or more computer-readable media according to claim 9, wherein the ETA calculating is based upon timing information of the tracked information about the present route and timing information the historical information from the collection of multiple trips along the determined known route.

14. One or more computer-readable media according to claim 9, wherein the operations further comprise matching timing information of the tracked information about the present route to a timing information of the historical information from the collection of multiple trips along the determined known route, wherein that collection has timing formation similar to that of the tracked information about the present route.

15. One or more computer-readable media according to claim 9, the operations further comprising:
encountering one or more ambient identifiable wireless signal (IWS) sources of the present route;
determining that the one or more of encountered ambient IWS sources match at least a portion of the series of encountered ambient IWS sources of the determined route;
triggering the calculating in response to a determination of a match, wherein the calculating is based upon the matching one or more of encountered ambient IWS sources.

16. One or more computer-readable media according to claim 9, wherein:
the tracking of information about the present route includes encountering a series of ambient identifiable wireless signal (IWS) sources while the mobile device is traveling along the present route, wherein the encountering includes:
detecting ambient IWS sources of the series while the wireless device is traveling;
identifying unique identification of detected ambient IWS sources of the series;
the determining matching route includes:
recognizing the present route in at least a portion of the series of encountered ambient IWS sources;
based upon the recognizing, determining which of route of a plurality of known routes mostly likely matches the present route;
selecting the determined known route as a match to the present route of mobile device travel.

17. One or more computer-readable media according to claim 9, wherein:
the tracking of information about the present route includes encountering a series of ambient identifiable wireless signal (IWS) sources while the wireless device is traveling along a present route;
the determining matching route includes:
recognizing the present route in at least a portion of the series of encountered ambient IWS sources;
based upon the recognizing, adjusting a confidence level associated with known routes;
based upon the confidence level associated with known routes, determining which of one or more known routes mostly likely matches the present route;
selecting the determined known route as a match to the present route of wireless device travel.

18. One or more computer-readable media according to claim 9, wherein the operations further comprising predicting a likely destination of the present route.

19. A method comprising:
tracking information about a present route that a mobile device is traveling, wherein the tracked information about the present route includes timing of encounters with one or more ambient identifiable wireless signal (IWS) sources of the present route;
determining which known route from amongst a plurality of known routes matches the present route that a mobile device is traveling;
obtaining historical information about a collection of multiple trips along the determined route, wherein the historical information about the collection of multiple trips along the determined route includes timing of encounters with one or more ambient identifiable wireless signal (IWS) sources of the determined route;
based upon tracked information about the present route and the historical information from the collection of multiple trips along the determined known route, calculating estimated time of arrival (ETA) at a likely destination of the present route.

20. A method according to claim 19, wherein the operations further comprise:
grouping multiple trips into affinity groups of trips based upon clusters of trip with similar timing of the encounters with the one or more ambient IWS sources of the determined route;
determining which affinity group of trips has timing of encounters of the determined route is closest to the timing of encounters of the present route; and
select the determined affinity group,
wherein the selected affinity group is the collection of multiple trips from which the historical information is obtained by the obtaining and from which the ETA calculating is based.

21. A method according to claim 19, wherein the ETA calculating is based upon timing information of the tracked information about the present route and timing information the historical information from the collection of multiple trips along the determined known route.

22. A method according to claim 19, wherein the operations further comprise matching timing information of the tracked information about the present route to a timing information of the historical information from the collection of multiple trips along the determined known route, wherein that collection has timing formation similar to that of the tracked information about the present route.

23. A method according to claim 19, the operations further comprising:
encountering one or more ambient identifiable wireless signal (IWS) sources of the present route;
determining that the one or more of encountered ambient IWS sources match at least a portion of the series of encountered ambient IWS sources of the determined route;
triggering the calculating in response to a determination of a match, wherein the calculating is based upon the matching one or more of encountered ambient IWS sources.

24. A method according to claim 19, wherein:
the tracking of information about the present route includes encountering a series of ambient identifiable wireless signal (IWS) sources while the mobile device is traveling along the present route, wherein the encountering includes:
detecting ambient IWS sources of the series while the wireless device is traveling;
identifying unique identification of detected ambient IWS sources of the series;
the determining matching route includes:
recognizing the present route in at least a portion of the series of encountered ambient IWS sources;
based upon the recognizing, determining which of route of a plurality of known routes mostly likely matches the present route;
selecting the determined known route as a match to the present route of mobile device travel.

25. A method according to claim 19, wherein the operations further comprising predicting a likely destination of the present route.
